(19) United States
(12) Patent Application Publication
(10) Pub. No.: US 2014/0095814 A1
(43) Pub. Date: Apr. 3, 2014

(54) Memory Renaming Mechanism in Microarchitecture

(71) Applicants: MORRIS MARDEN, Hillsboro, OR (US); VIJAYKUMAR VIJAY KADGI, Portland, OK (US); JAMES D. HADLEY, Portland, OR (US); MATTHEW C. MERTEN, Hillsboro, OR (US); GRACE C. LEE, Portland, OR (US); JOSEPH A. MCMAHON, Portland, OR (US); ROBERT S. CHAPPELL, Portland, OR (US); LAURA A. KNAUTH, Portland, OR (US); FARIBORZ TABESH, Portland, OR (US)

(72) Inventors: MORRIS MARDEN, Hillsboro, OR (US); VIJAYKUMAR VIJAY KADGI, Portland, OK (US); JAMES D. HADLEY, Portland, OR (US); MATTHEW C. MERTEN, Hillsboro, OR (US); GRACE C. LEE, Portland, OR (US); JOSEPH A. MCMAHON, Portland, OR (US); ROBERT S. CHAPPELL, Portland, OR (US); LAURA A. KNAUTH, Portland, OR (US); FARIBORZ TABESH, Portland, OR (US)

(21) Appl. No.: 13/631,644

(22) Filed: Sep. 28, 2012

(51) Int. Cl. G06F 12/00

(52) U.S. Cl. 711/156; 711/E12.001

(57) ABSTRACT

A processor includes a processing unit including a storage module having stored thereon a table for tracking physical registers in which each store operation stores source data and a memory renaming module for register renaming load operations based on the table.

### FIELD OF THE INVENTION

The present disclosure pertains to managing registers that reside inside CPUs, in particular, to memory renaming mechanisms for tracking the mapping between logical registers and their corresponding physical registers to facilitate the out-of-order execution of instructions and/or micro-operations.

### BACKGROUND

Hardware processors include one or more central processing unit (CPU) which each may further include a number of physical registers for staging data between various functional units as well as between memory and functional units in CPUs. Register renaming may be used to increase the speed of instruction execution by parallelizing the execution of independent writer-reader instruction sets (often referred to as lifetimes). Table 1 is an illustrative example of independent writer-reader sets.

TABLE 1

RAX = first operation
. . .
Store [ADDRESS] ←RAX
...
RAX = Load [ADDRESS']
. . . second operation on RAX

In this example, a logical register RAX which is mapped to a physical register M inside the CPU may receive the result of the first operation. The value of the result may be stored in a memory location (at ADDRESS). Subsequently, the value stored in a different memory location (at ADDRESS′) may be loaded to logical register RAX on which a second operation may be performed. Although the memory write (Store) and memory read (Load) operations are directed at the same logical register RAX, the memory read operation is not dependent on the execution of all of the prior instructions such as the first operation, and thus the hardware assigns this second lifetime of RAX to a different physical register. For example, the write to the physical register associated with the second RAX lifetime may have completed before the full execution of the first operation. Thus, register renaming may be used to facilitate out of order execution of the independent writer-reader sets.

### DESCRIPTION OF THE FIGURES

Embodiments are illustrated by way of example and not limitation in the Figures of the accompanying drawings:

FIG. 1 is a block diagram of a system according to one embodiment of the present invention.

FIG. 2 is a block diagram of a system for memory renaming according to an embodiment of the present invention.

FIG. 3 is a block diagram of a system for memory renaming according to another embodiment of the present invention.

FIG. 4 is a memory rename table according to an embodiment of the present invention.

FIG. 5 illustrates a method of using memory rename table for memory renaming according to an embodiment of the present invention.

FIG. 6 illustrates execution of a writer-reader set without using a memory renaming table.

FIG. 7 illustrates execution of a writer-reader set using a memory renaming table according to an embodiment of the present invention.

FIG. 8 illustrates execution of another writer-reader set using a memory renaming table according to an embodiment of the present invention.

FIG. 9 is a memory rename table according to another embodiment of the present invention.

### DETAILED DESCRIPTION

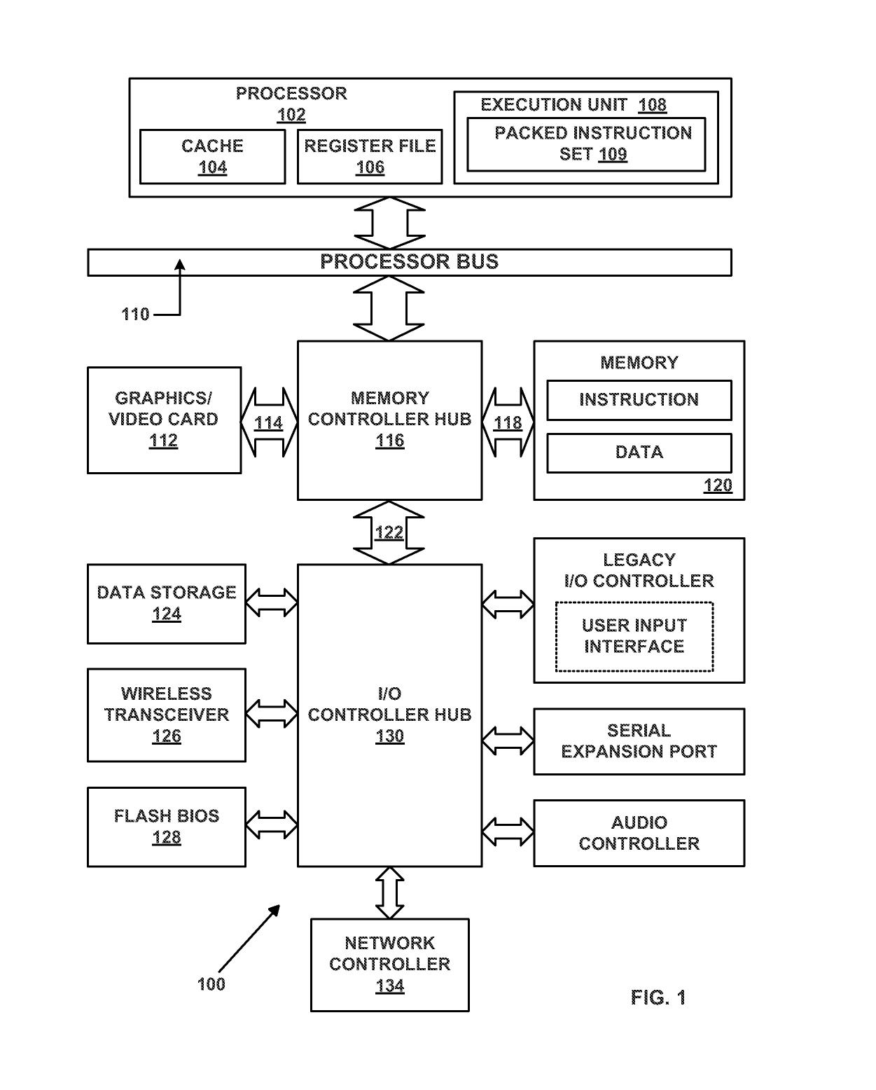

Embodiments of the present invention may include a computer system as shown in FIG. 1. The computer system 100 is formed with a processor 102 that includes one or more execution units 108 to perform an algorithm to perform at least one instruction in accordance with one embodiment of the present invention. One embodiment may be described in the context of a single processor desktop or server system, but alternative embodiments can be included in a multiprocessor system. System 100 is an example of a ‘hub’ system architecture. The computer system 100 includes a processor 102 to process data signals. The processor 102 can be a complex instruction set computer (CISC) microprocessor, a reduced instruction set computing (RISC) microprocessor, a very long instruction word (VLIW) microprocessor, a processor implementing a combination of instruction sets, or any other processor device, such as a digital signal processor, for example. The processor 102 is coupled to a processor bus 110 that can transmit data signals between the processor 102 and other components in the system 100. The elements of system 100 perform their conventional functions that are well known to those familiar with the art.

In one embodiment, the processor 102 includes a Level 1 (L1) internal cache memory 104. Depending on the architecture, the processor 102 can have a single internal cache or multiple levels of internal cache. Alternatively, in another embodiment, the cache memory can reside external to the processor 102. Other embodiments can also include a combination of both internal and external caches depending on the particular implementation and needs. Register file 106 can store different types of data in various registers including integer registers, floating point registers, status registers, and instruction pointer register.

Execution unit 108, including logic to perform integer and floating point operations, also resides in the processor 102. The processor 102 also includes a microcode (ucode) ROM that stores microcode for certain macroinstructions. For one embodiment, execution unit 108 includes logic to handle a packed instruction set 109. By including the packed instruction set 109 in the instruction set of a general-purpose processor 102, along with associated circuitry to execute the instructions, the operations used by many multimedia applications may be performed using packed data in a general-purpose processor 102. Thus, many multimedia applications can be accelerated and executed more efficiently by using the full width of a processor's data bus for performing operations on packed data. This can eliminate the need to transfer smaller units of data across the processor's data bus to perform one or more operations one data element at a time.

Alternate embodiments of an execution unit 108 can also be used in micro controllers, embedded processors, graphics devices, DSPs, and other types of logic circuits. System 100 includes a memory 120. Memory 120 can be a dynamic random access memory (DRAM) device, a static random access memory (SRAM) device, flash memory device, or other memory device. Memory 120 can store instructions and/or data represented by data signals that can be executed by the processor 102.

A system logic chip 116 is coupled to the processor bus 110 and memory 120. The system logic chip 116 in the illustrated embodiment is a memory controller hub (MCH). The processor 102 can communicate to the MCH 116 via a processor bus 110. The MCH 116 provides a high bandwidth memory path 118 to memory 120 for instruction and data storage and for storage of graphics commands, data and textures. The MCH 116 is to direct data signals between the processor 102, memory 120, and other components in the system 100 and to bridge the data signals between processor bus 110, memory 120, and system I/O 122. In some embodiments, the system logic chip 116 can provide a graphics port for coupling to a graphics controller 112. The MCH 116 is coupled to memory 120 through a memory interface 118. The graphics card 112 is coupled to the MCH 116 through an Accelerated Graphics Port (AGP) interconnect 114.

System 100 uses a proprietary hub interface bus 122 to couple the MCH 116 to the I/O controller hub (ICH) 130. The ICH 130 provides direct connections to some I/O devices via a local I/O bus. The local I/O bus is a high-speed I/O bus for connecting peripherals to the memory 120, chipset, and processor 102. Some examples are the audio controller, firmware hub (flash BIOS) 128, wireless transceiver 126, data storage 124, legacy I/O controller containing user input and keyboard interfaces, a serial expansion port such as Universal Serial Bus (USB), and a network controller 134. The data storage device 124 can comprise a hard disk drive, a floppy disk drive, a CD-ROM device, a flash memory device, or other mass storage device.

For another embodiment of a system, an instruction in accordance with one embodiment can be used with a system on a chip. One embodiment of a system on a chip comprises of a processor and a memory. The memory for one such system is a flash memory. The flash memory can be located on the same die as the processor and other system components. Additionally, other logic blocks such as a memory controller or graphics controller can also be located on a system on a chip.

Embodiments of the present invention may include a processor including a processing unit such as a central processing unit (CPU) that further includes a storage module having stored thereon a table for tracking physical registers for store operations, the store operations storing source data from physical registers into memory, and a memory renaming module for renaming load logical register destinations to physical registers based on the table.

Embodiments of the present invention may include a method for register renaming in a processor. The method includes in response to a store operation of a producer command, writing, in an entry of a table, a physical register identification number and an associated store buffer number of the store operation, and performing the register renaming based on the table.

Embodiments of the present invention may include a method for memory renaming which includes in response to a load operation of a consumer command, predicting an entry in a memory renaming table as a potential renaming physical register, determining if the predicted entry is valid, if the predicted entry is valid, identifying a physical register ID in the predicted entry, and mapping a logical register destination of the load operation in a register alias table with the identified physical register ID.

Table 2 is an illustrative example of a different case, where the lifetime of RBX is in fact dependent on the lifetime of RAX through the memory location ADDRESS.

TABLE 2

RAX = first operation
. . .
Store [ADDRESS] ←RAX
. . . (no intervening write to [ADDRESS])
RBX = Load [ADDRESS]
. . . second operation on RBX

In this example, RAX is produced by the first operation (the producer), and moved into RBX via a store to and load from a memory location. An out-of-order (“OOO”) execution engine employs a memory renaming technique to eliminate the unnecessary latency to the second operation incurred by the store-load pair by keeping a copy of the stored data value in a location directly accessible by the execution units in the OOO. A Register Alias Table (RAT) is commonly used to track the mappings between logical registers (such as RAX) and their corresponding physical registers inside the CPU. Thus, for each Store or Load operation, the respective source or destination logical register may be associated with a respective corresponding physical register ID in the RAT. The OOO execution engine inside the CPU may execute several independent writer-reader sets (or lifetimes) of the same logical register at the same time. The youngest (latest) version of the logical register as seen at the CPU's allocator is referred to as the “current” version from which subsequent new allocating instructions/micro-operations depend on. An instruction/micro-operation may commit the result (“retire”) the instruction/micro-operation after all older (or prior) instructions/micro-operations have retired.

The exemplary Table 2 may include different execution scenarios. For example, it is possible that logical register RAX is overwritten between the Store operation and the Load operation. In such a case, the logical register RAX is being used for other computations other than the first operation at the time of the execution of the Load allocation. However, versions of the original RAX may still be alive in the out-of-order execution engine, being referenced through the corresponding physical register ID. In this scenario, memory renaming is still possible while that physical register is still alive (it contains the result of the first operation). But tracking via logical register name aliasing (such as whether RAX and RBX share the same value) is not viable because the allocation-time view of RAX already references something else when the second operation allocates.

In other cases, all of the references to the original logical register RAX have executed and retired at the time of allocation of the second operation, and thus the original physical register may have been reclaimed to the free list. In this case, the value of the original logical register is no longer in the out-of-order engine, and thus the Load operation is needed to load the value from memory. Alternatively, reclamation of the original physical register could be delayed to facilitate later memory renaming. However, the delay has a performance overhead of reducing the number of available physical registers for general out-of-order execution for the hope that the original physical register might be used for memory renaming.

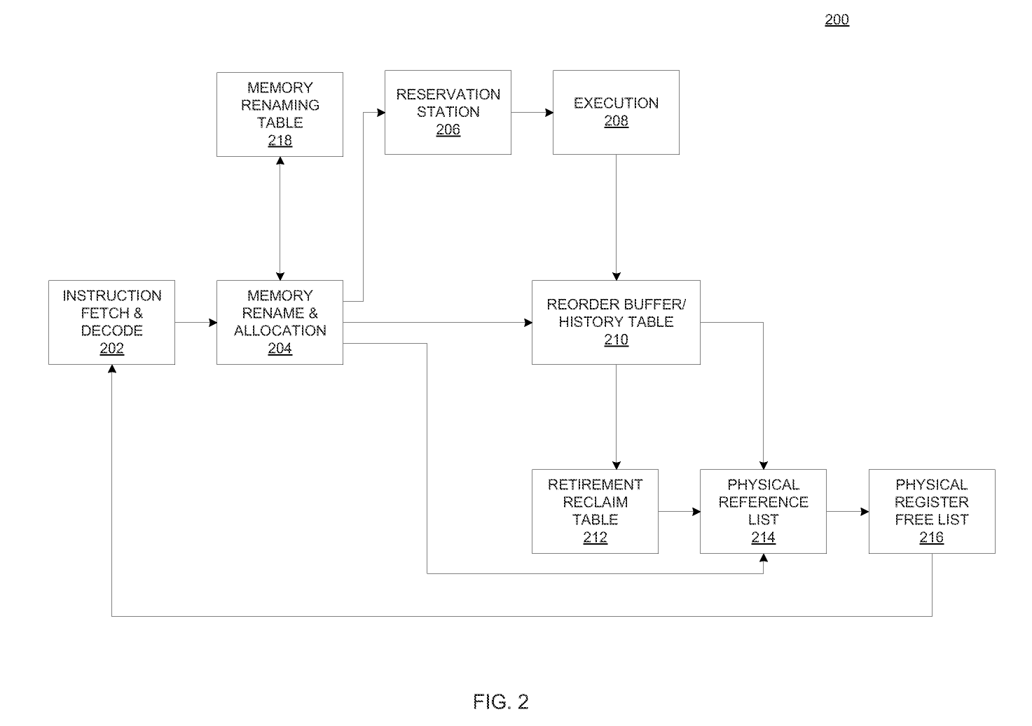

FIG. 2 is a block diagram of a system 200 for register renaming according to an embodiment of the present invention. The system 200 may include circuit logics inside a CPU that may be configured to perform register renaming functions. The system 200 as illustrated in FIG. 2 may include an instruction fetch and decode module 202, a rename and allocation module 204, a reservation station 206, an execution module 208, a recorder buffer and history buffer 210, a retirement reclaim table 212, a physical reference list 214, and a physical register free list 216. Further, the system 200 may include a memory renaming table 218.

The instruction fetch and decode module 202 may fetch instructions/micro-operations from an instruction cache and decode the instruction/micro-operation in preparation for execution. The decoded instructions/micro-operations may include Store operation and Load operation pairs (writer-reader sets) that may be sped up through memory renaming. In response to receiving a writer-reader set that can be optimized by memory renaming, the rename and allocation module 204 may initiate memory renaming. The rename and allocation module 204 may include a register alias table (RAT) (not shown) for tracking the mappings between logical registers and physical registers. Additionally, the rename and allocation module 204 may be communicatively connected to a storage component stored thereon a memory renaming table (MRT) 218 that tracks the physical register identification number for each store operation. Based on the information from MRT and RAT, the rename and allocation module 204 may rename logical registers, and may remove the store-load pair from the execution path by associating the destination of the load operation with the data source of the store operation, and further convert the load into a load check operation that verifies at retirement time whether the conversion was legal. It is determined to be legal provided that there were no intervening writes to the store/load memory address. A detailed discussion of the memory renaming mechanism is provided below in conjunction with the description of FIG. 2.

The reservation station 206 is a logic circuit that may start to schedule independent operations out-of-order with respect to program (allocation) order. Consider the Load and Second Operation in Table 1. These instructions are not data dependent on the Store and First Operation, and can be executed in parallel. However, the Store instruction is data dependent on the First Operation, and so the reservation station 206 will execute those in order. Likewise, the Load and Second Operation must be executed in order. Referring to Table 2, the Load operation is data dependent on the Store operation because the Load is from the same address as the Store, thus the reservation station 206 would ensure all four instructions execute in order. In response to the initiation of memory renaming by the rename and allocation module, the reservation station 206 can execute the Second Operation out-of-order immediately after the first operation, thus bypassing memory, as well as execute the Store and Load operation (the latter converted to a load check instruction) in order following the First Operation. The execution module 208 is the logic circuit that executes the instructions. The reorder buffer and history table 210 may retain the execution results executed out-of-order, ensuring they are committed in order. In particular, the history buffer may store several mappings of logical registers to physical registers pertaining to several lifetimes of the same logical register that are alive in the out-of-order engine so that if a branch misprediction occurs, the correct mapping for the lifetime at the point of the misprediction may be restored so execution can resume on the correct path. The reorder buffer is a structure that sequentially indexing instructions in flight on a per-operation basis. After an instruction has executed (this information may be acquired from the reorder buffer), the instruction may be committed. All of the committed instructions may be indexed in the retirement reclaim table, which contains a list of the physical registers that are no longer needed once the committed instructions retire. For example, when an instruction that writes the RAX logical register retires, there can be no more instructions remaining in the machine that can refer to a previous version of RAX, and therefore the physical register that held that old value can be reclaimed to the physical register free list 216. However, through memory renaming, RBX might also be associated with the same physical register, such as at the end of the instruction sequence in Table 2. Since there may be multiple references to a physical register due to memory renaming, the physical reference list (PRL) is a data structure stored on a storage component that tracks the multiple references to the physical register. Once all references to a value have been overwritten as tracked by the PRL, an identification of the physical register may be placed on the physical register free list 216 and made available for instruction fetch and decode module 202.

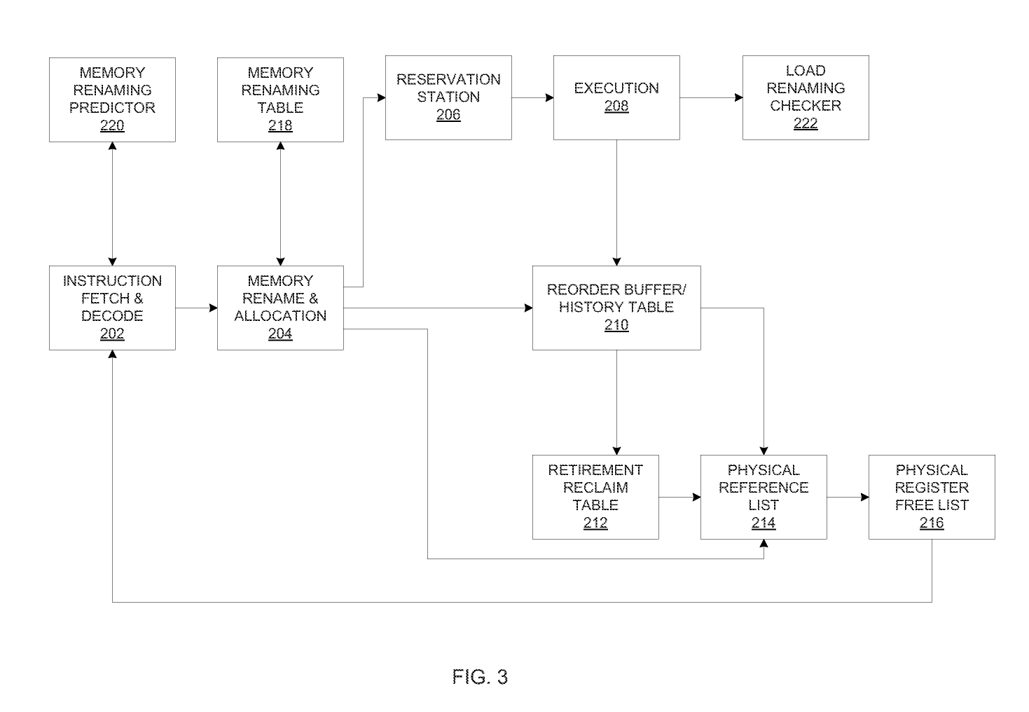

FIG. 3 is a block diagram of the system 200 that includes additional components according to another embodiment of the present invention. The system 200 as shown in FIG. 3 includes all of the components as arranged in FIG. 2 and additionally include a memory renaming predictor 220 and optionally a load renaming checker 222. The memory renaming predictor 220 is coupled to the instruction fetch and decode module 202 and is configured to predict (a) which Load operations are likely to memory rename and to which Store operation source register the data may come from, and optionally (b) which store source registers to delay reclamation in order to increase the likelihood of renaming to a load. The output of the memory renaming predictor 220 may be an offset value (n) from most recent Store allocated. The load renaming checker 222 may be coupled to the execution module 208 for ensuring that the Load operation would have obtained its data from the predicted Store operation and verify that the register renaming was correct.

Referring to FIG. 3, in response to fetching a Load operation of a writer-reader set, the memory renaming predictor 220 may make a determination of whether the Load operation is likely to rename and if so, predict from which Store operation the data source (a physical register) may come from.

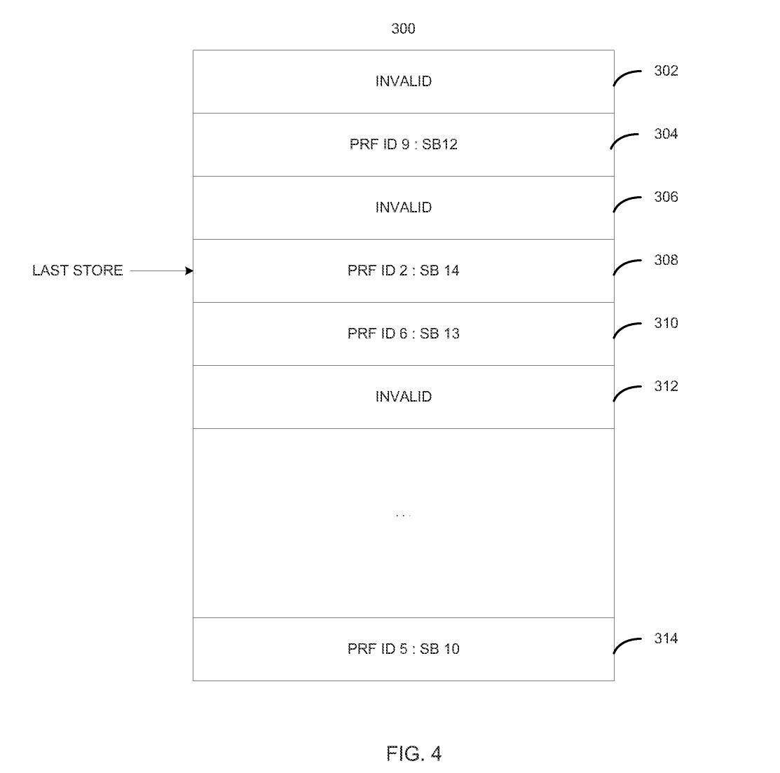

FIG. 4 is a memory rename table 300 according to an embodiment of the present invention which may be stored in a hardware storage device such as RAM memory that includes a read port and a write port. The memory rename table 300 may be stored as a table data structure that includes a plurality of entries 302-314. Each entry may be unoccupied (indicated as INVALID) or occupied. The unoccupied entries such as 302, 306, 312 are available for storing the mapping between a physical register and a future Store operation. The occupied entries such as 304, 308, 310, 314 store mappings of prior Store operations to physical registers. The mapping in each occupied entry may be in the form of physical register ID number and store buffer ID number. The physical register ID number identifies a physical register, while each valid entry is associated with a unique store buffer ID number that uniquely identifies a Store operation. Thus, when a store allocates, the source physical register ID is placed into an entry in the MRT table that may be tagged with the store buffer ID number. On the other hand, when a physical register is reclaimed from the out-of-order execution engine to the free list, all reference to the physical register in the MRT may need to be removed so no further memory renaming is performed. Otherwise, another Load operation may try to share a physical register once associated with a Store that has since been reallocated for other purposes. Therefore, if a store's source is no longer in the out-of-order engine (that is, an overwriter of the logical source of the store's data has been committed, and overwriters for all memory renamed logical registers associated with that same physical register have been committed), the store should be invalidated in the MRT to prevent future renaming to loads. In one embodiment, an MRT entry is removed in response to the physical register associated with the store buffer is reclaimed, and new entries are inserted based on a free entry search and lookups in the MRT are performed by CAM match on the Store Buffer ID.

For example, FIG. 4 shows that entry 308 is entered for the last Store operation which associates Store Buffer 14 with physical register ID 2. If, in response to a subsequent Load operation of RDX=load [ADDR], the memory renaming predictor 220 predicts an offset value n=−1, entry 310 may be identified so that RDX in RAT is associated with the physical register 6 from store buffer 13 (which equals to 14-1) as stored in entry 310 through a CAM match.

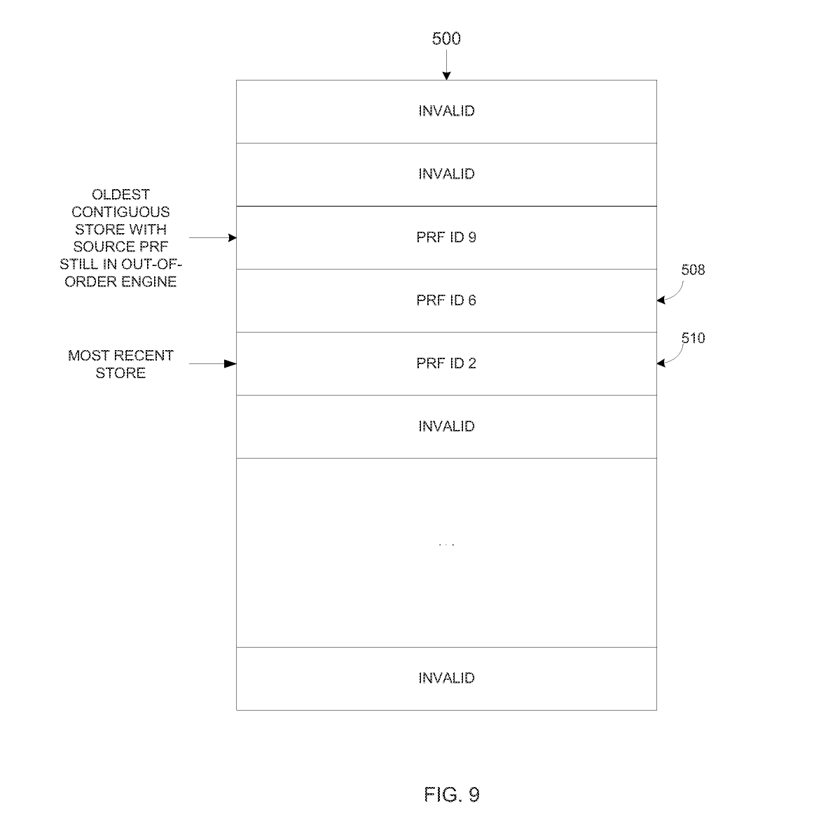

In another embodiment, MRT may contain a contiguous set of stores in the order of program code, rather than piecemeal set of still eligible stores. FIG. 9 illustrates a memory rename table that includes a contiguous set according to another embodiment of the present invention. Managing a contiguous set of stores allows for a much simpler FIFO method of tracking stores. It may be very costly to track all of the stores that could rename even long after the stores complete and retire because their source data registers might continue to exist in the out-of-order machine (inside the RAT) indefinitely. Therefore, MRT as illustrated in FIG. 9 may provide an effective trade-off between the cost of tracking stores and physical register renaming.

Referring to FIG. 9, MRT 500 may include a contiguous set of entries for store operations. At the bottom end of the contiguous set is the entry for the most recent store. At the top end of the set is the oldest contiguous store with source physical register is still in the out-of-order execution engine. For simplification, a store entry may be removed from the MRT 500 when the Store retires regardless if the Store's source register continues to exist, thereby making reclamation in the MRT 500 a simple in-order pointer advancement algorithm. Because of this, the Load operation is seen inside the same out-of-order execution window as the Store operation, which limits the time period in which a memory renaming could have been performed. While this may reduce memory renaming opportunities, and thus the benefits of memory renaming, the lost opportunity may be small because many store and load operation pairs are short and fall within the same out-of-order execution window. For example, parameters may be passed from caller to callee through memory within the same out-of-order execution window.

For example, FIG. 9 shows that entry 308 is entered for the last Store operation with physical register ID 2 (510). If, in response to a subsequent Load operation of RDX=load [ADDR], the memory renaming predictor 220 predicts an offset value n=−1, entry 508 may be identified so that RDX in RAT is associated with the physical register 6.

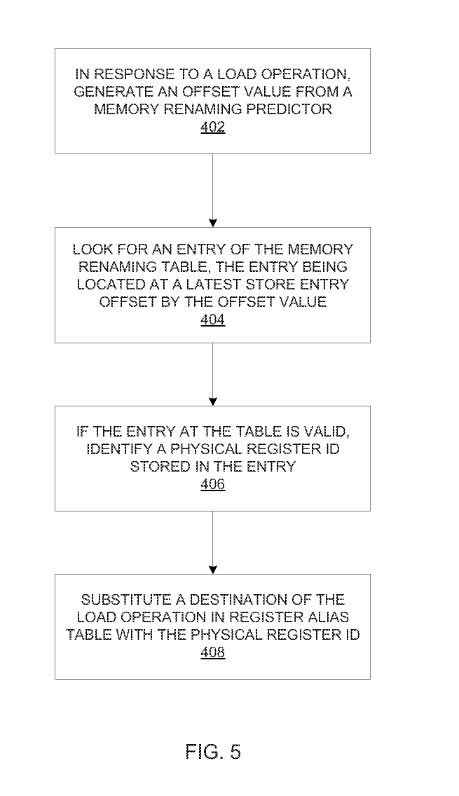

FIG. 5 illustrates a method of using memory rename table for register renaming according to an embodiment of the present invention. At 402, in response to a Load operation, the memory renaming predictor 220 may predict an entry of a Store operation in the MRT 218 that may have the physical register that holds the data to be shared with the Load operation. In one embodiment, the prediction may be an offset value from the entry of the latest Store operation. At 404, an entry of the MRT 218 may be located based on the entry for the latest Store operation and the offset value. In one embodiment, the located entry is the entry for the latest Store operation offset by the offset value. At 406, it is determined if the located entry is valid. If the entry is valid, physical register ID number stored in the entry may be identified. At 408, the physical register ID number may be used to replace the destination of the Load operation stored in the register alias table (RAT).

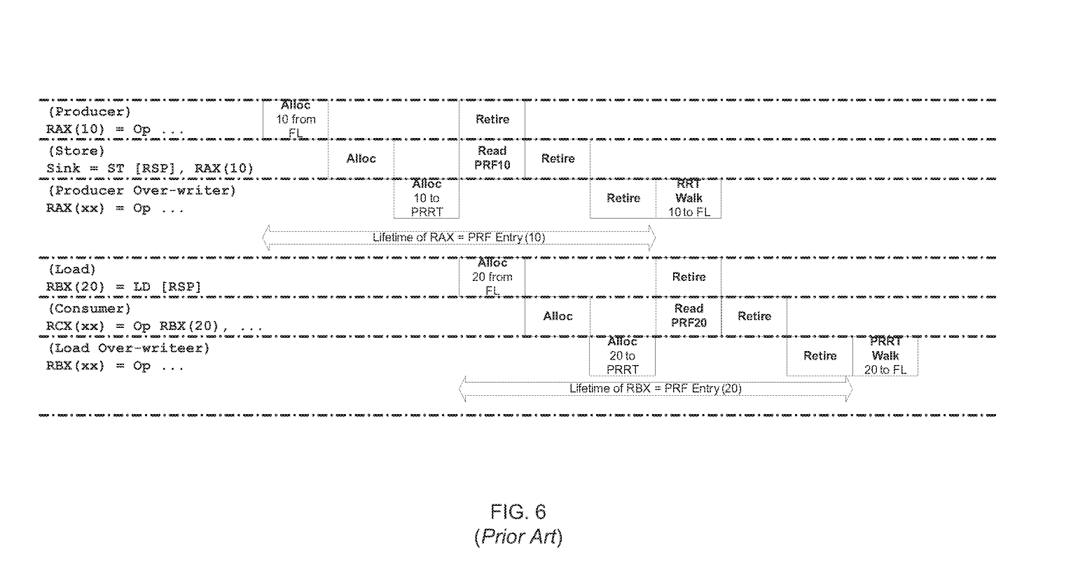

FIG. 6 illustrates execution of a writer-reader set without using a memory renaming technology. The operations include a Producer (including Store) and Consumer (including Load) pair. In this example, at the top of FIG. 6, the lifetimes of the Producer, the Store, and the Over-writer for the logical register RAX are shown as time progress from left to right. As shown in FIG. 6, the lifetime of physical register entry 10 (PRF 10) lasts 3 uops. The bottom portion of FIG. 6 depicts a similar timelines for the Load, the Consumer, and the Over-writer for RBX. Without memory renaming, RBX receives its own physical register ID (20). Like the Producer, RBX's lifetime lasts from its allocation until the over-writer retires. In this example, two physical register IDs (10, 20) are used during the lifetimes of the Producer (Store) and Consumer (Load) Operations.

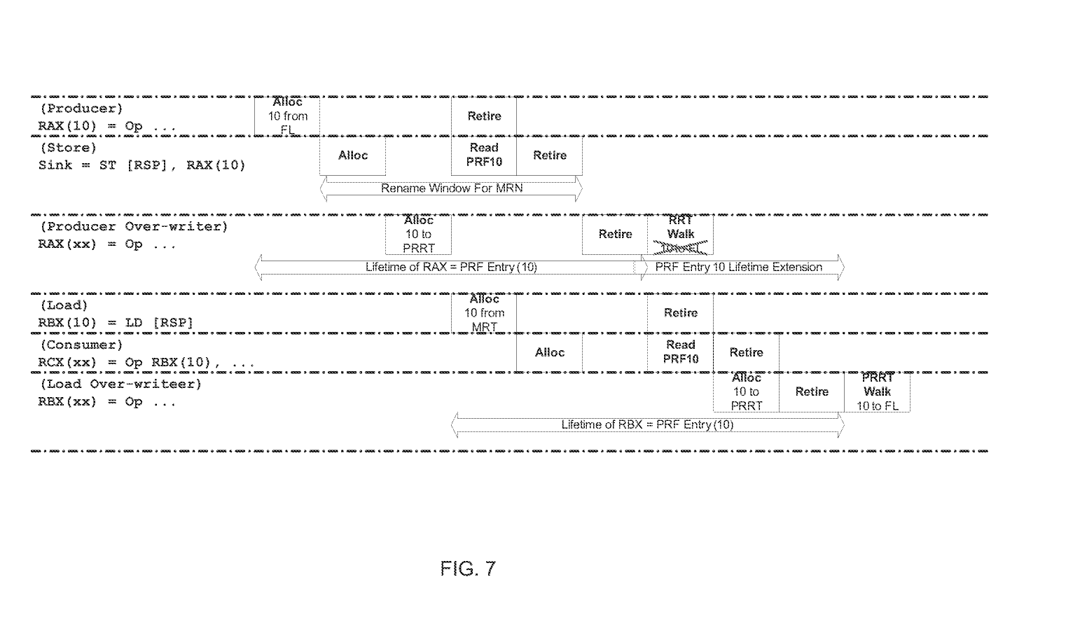

FIG. 7 illustrates execution of a writer-reader set using a memory renaming table according to an embodiment of the present invention. In this embodiment, the physical register 10 is not reclaimed to the freelist after the retirement of Producer over-writer RAX, and the Load operation does not receive a new physical register entry. Instead, the Load reads the Producer Store's source physical register ID from MRT (which by definition is the Producer's destination physical register ID) and assigns the destination physical register ID to the logical register RBX in the RAT. While the lifetimes of the individual logical registers (RAX, RBX) remain the same since ability of instructions to access the physical registers by way of their logical register names has not changed, the lifetime of the physical register (10) now is the combination of the two lifetimes. It is noted that the actual Consumer read does not occur until outside the lifetime of RAX (or the original lifetime for physical register 10). The RAT may extend the lifetimes of the share physical register to ensure that the physical register is not reclaimed before all Consumer reads have completed. After all Consumer reads are finished, the physical register may be reclaimed to the free list.

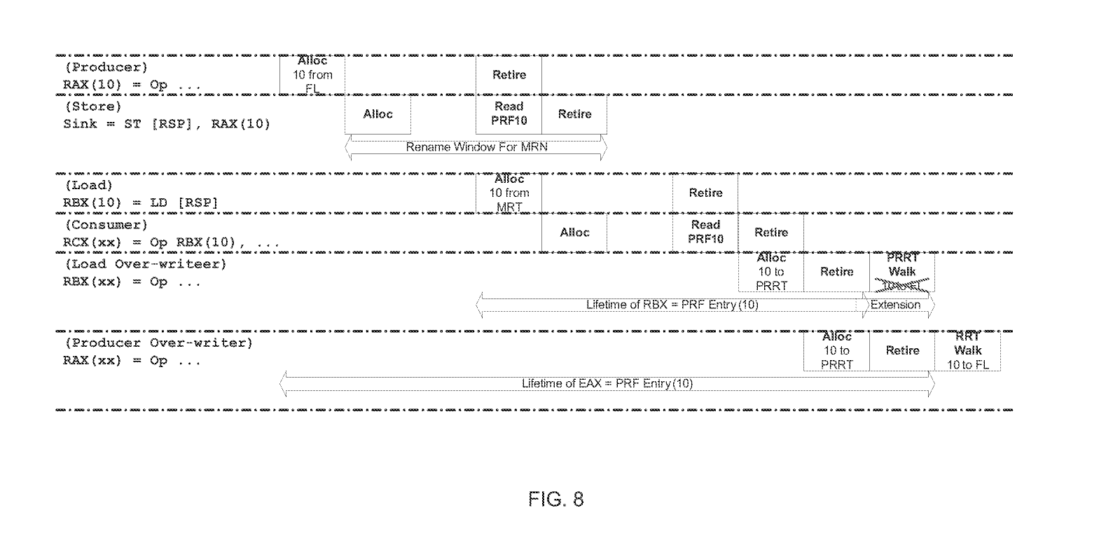

It is possible that the Producer Over-writer does not appear in the application until after the Load Over-writer. FIG. 8 illustrates execution of writer-reader set using a memory renaming table for such a scenario according to an embodiment of the present invention. In this embodiment, the lifetime of RAX may be a superset of the lifetime of RBX, i.e., it may, by itself, represent the lifetime of physical register 10.

While FIG. 4 illustrates one embodiment of MRT, MRT may be in other forms. In one embodiment, MRT may have a limited number of entries such that only a subset of the eligible stores are made available to MRT. The subset of stores could be a pre-determined number of most recent stores, or it could be a set of stores that are predicted to rename to loads

In another embodiment, the MRT may always retain physical register of n past store operations (where n is an integer) to prevent these physical registers from reclamation to the free list, even if the store's data source register is overwritten and retired. If there are no references inside the out-of-order engine, the physical register is reclaimed to the free list when it exits the MRT, for example, when it is no longer one of the n most recent store operations.

To track the existence of multiple logical references to a single physical register file (PRF) entry and prevent their early reclamation, a physical reference list (PRL) 214 as shown in FIG. 3 may be used. A new entry in the PRL is allocated whenever a new logical register is mapped to an already allocated PRF entry. Thus, the number of PRL entries for a particular PRF Id indicates the number of extra mappings that PRF entry has beyond its original one. When over-writers retire, the physical entry IDs in the Retirement Rename Table are checked against the PRL as they are reclaimed before being placed in the free list. If the PRF ID exists in the PRL, multiple logical references to that PRF entry may still exist in the out-of-order engine. These PRF entries are not reclaimed (or, placed in the free list). Instead, one of the matching PRL entries is deleted from the PRL. If no PRF ID exists in the PRL, which means that no other references to that PRF entry exist, it is safe to reclaim the PRF entry and move it to the free list.

In one embodiment, when a register is renamed for a Load operation, a memory execution unit (MEU) may need to perform a check to ensure that the predicted Store-to-Load data dependence actually exists. Therefore, during memory renaming, the Load operation is converted into a load check micro-operation which proceeds to execute in the memory unit, but does not write back any data values to the execution units. The MEU may perform the standard store/load ordering check based on the computed addresses of all loads and stores. The memory address of load should be aligned with the store, and that the size of load should be the same or smaller than the size of the store. If the load address and size do not match those of the store, the load operation should trigger a fault condition and should be re-executed without performing memory renaming.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A processor, comprising:
a processing unit including:
a storage module having stored thereon a table for tracking physical registers for store operations, the store operations storing source data from physical registers in memory; and
a memory renaming module for renaming physical registers based on the table.

2. The processor of claim 1, wherein the table includes a plurality of entries, and wherein each valid entry includes a mapping between a physical register and a store buffer of a store operation.

3. The processor of claim 1, further comprising:
a memory renaming predictor for, in response to a load operation subsequent to a store operation, predicting an entry of a potential renaming physical register stored in the table.

4. The processor of claim 3, wherein the memory renaming predictor predicts, in the table, an offset from the latest store operation.

5. The processor of claim 4, wherein the memory renaming module is configured to
receive the offset;
identify a target entry in the table based on the latest store operation and the offset;
identify a physical register identification number stored in the target entry; and
update an entry for the load operation in a register alias table with the physical register identification number.

6. The processor of claim 5, further comprising an execution module for executing instructions based on dependencies derived from the register alias table

7. The processor of claim 6, wherein the execution module starts execution of a consumer operation in a clock cycle immediately after execution of a producer operation.

8. The processor of claim 6, wherein the physical register is reclaimed into a free list after all local registers associated with the physical register have been overwritten and all over-writers have been retired.

9. The processor of claim 8, wherein, in response to reclamation of the physical register, all entries of the table that are associated with the physical register are invalidated.

10. The processor of claim 1, wherein the table includes a contiguous set of valid entries that are written to the table sequentially according to an order of store operations, and wherein each entry includes a physical register identification number associated with a corresponding store operation.

11. The processor of claim 10, wherein the memory renaming module is configure to remove an entry of the store operation from the table upon retirement of the store operation.

12. The processor of claim 1, further comprising:
an instruction fetch and decode module for fetching and decoding instructions from an execution pipeline, and
a second storage module having stored thereon a physical reference list for tracking existence of multiple logical references to a single physical register.

13. A method for register renaming in a processor, comprising:
in response to a store operation of a producer command, writing, in an entry of a table, a physical register identification number, and
performing the memory renaming based on the table.

14. The method of claim 13, wherein the table includes a plurality of entries, and wherein each valid entry includes a mapping for a physical register to a store buffer of a store operation.

15. The method of claim 13, further comprising:
in response to a load operation subsequent to a store operation, receiving a predicted entry for the table from a memory renaming predictor, wherein the predicted entry is predicted as a potential renaming register.

16. The method of claim 15, wherein the memory renaming predictor predicts an offset from an entry of a latest store operation, and a memory renaming module in the processor is configured to
receive the offset;
identify a target entry in the table based on the entry for the latest store operation and the offset;
identify a physical register identification number stored in the target entry; and
update an entry for the load operation in a register alias table with the physical register identification number.

17. A method for memory renaming, comprising:
in response to a load operation of a consumer command, predicting an entry in a memory renaming table as a potential renaming register;
determining if the predicted entry is valid;
if the predicted entry is valid, identifying a physical register ID in the predicted entry; and
substituting a destination of the load operation in a register alias table with the identified physical register ID.

18. The method of claim 17, further comprising:
executing instructions based on dependencies derived from the register alias table.

19. The method of claim 18, wherein a consumer operation is executed in a clock cycle immediately after execution of a producer operation.

20. The method of claim 17, wherein the physical register is reclaimed into a free list after all registers associated with the physical register have been overwritten and all over-writers have been retired.

21. The method of claim 20, wherein in response to reclamation of the physical register, all entries of the table that are associated with the physical register are invalidated.

22. The method of claim 20, wherein in response to retirement of a store instruction, the entry in the table that is associated with that store instruction is invalidated.
